(19) United States
(12) Patent Application Publication
(10) Pub. No.: US 2016/0269100 A1
(43) Pub. Date: Sep. 15, 2016

(54) SATELLITE LASER COMMUNICATIONS RELAY NODE

(71) Applicant: The Aerospace Corporation, El Segundo, CA (US)

(72) Inventor: Richard P. WELLE, Sunset Beach, CA (US)

(21) Appl. No.: 15/067,785

(22) Filed: Mar. 11, 2016

Related U.S. Application Data
(60) Provisional application No. 62/131,692, filed on Mar. 11, 2015.

(51) Int. Cl. H04B 7/185; H04B 10/29; H04B 10/112; H04B 10/50

(52) U.S. Cl. CPC H04B 7/18521; H04B 7/18513; H04B 7/18519; H04B 10/503; H04B 10/29; H04B 10/1129

(57) ABSTRACT

A relay satellite node is provided. The relay satellite node may enable separate pointing of a receive portion and transmit portion of the node, enabling continuous communication through the node. The node may include two separate satellites flying in close proximity to one another. One of the satellites may use its attitude-control system to enable high-gain communications from a distant source, and the other satellite may use its attitude-control system to enable high-gain communication to a distant receiver. The two satellites may communicate with one another over a high-rate, short-range, omnidirectional communication system. A LEO network of these nodes, in combination with dedicated client-specific relay satellites may provide high-rate communication between any space asset and a ground network with latency limited only by the speed of light.

### CROSS-REFERENCE TO RELATED APPLICATIONS

This application claims priority to U.S. Provisional Patent Application No. 62/131,692, filed Mar. 11, 2015, entitled “CubeSat Laser Communications Relay Node,” which is hereby incorporated by reference in its entirety.

### FIELD

The present invention relates to an application of a relay node, and in particular, a communications relay node.

### BACKGROUND

Recent progress in sensor technology has allowed low Earth orbit (LEO) satellites to shrink significantly in size, disrupting a legacy industry where traditional satellites cost 500 million dollars to 1 billion dollars to build and launch. Major investments are being made to address the new opportunities that this provide for data collection, and many companies are launching nanosatellites and/or microsatellites into LEO to capture this opportunity. The rapidly expanding satellite infrastructure is generating vast amounts of data, reaching nearly 20 PB/year in 2014, with no signs that the trend will level off. To bring all that data down from LEO requires an average communication rate of 5 Gb/s, continuously, and that demand will continue to grow.

Typically, most satellites download data via space-to-ground radio-frequency (RF) links, communicating directly with fixed ground stations as the satellites fly within range. The current ground station infrastructure has several key limitations that present significant challenges as the satellite industry continues to grow. Satellite-to-ground communications are “line-of-sight,” meaning that ground stations must receive data only from satellites that are directly above the local horizon. The duration of a satellite passes over a ground station depends on the altitude of the satellite and the distance between the ground station and the ground track of the satellite. With satellites in LEO, the maximum pass duration is typically less than ten minutes.

The frequency of passes is strongly dependent on the satellite orbit parameters and the location of the ground station. For example, a satellite in equatorial orbit will pass over an equatorial ground station on each orbit. This means that with a typical orbital period of 90 minutes, the satellite will pass the ground station 16 times per day. Similarly, a satellite in a polar orbit will pass over a ground station located at the North Pole once per orbit. On the other hand, the satellite in polar orbit will pass over the equatorial ground station between two and four times per day depending on the alignment of the ground track with the location of the ground station.

However, it should be noted that the satellite in equatorial orbit will never pass over the polar ground station. Most LEO satellites are in orbits at some inclination between equatorial and polar, and most ground stations are located at latitudes well south of the North Pole. As such, the pass frequency for any given satellite over any given ground location will typically be three to five times per day for ground stations that are not at high latitude (above about 60 degrees) and not at latitudes higher than the orbital inclination of the satellite.

The consequence of limitations on pass duration and frequency is that a satellite will be within communication range of a given ground station for no more than 10 percent of a day, and typically for less than 2 percent of the day. These constraints on pass duration and pass frequency are driven by orbital dynamics and can be overcome only by increasing the number of ground stations or locating the ground stations at very high latitudes. However, increasing the number of ground stations require a large amount of capital investment. Furthermore, avoiding downlink constraints requires a large number of geographically diverse ground stations that are inherently underutilized.

To compensate for the limitations on ground contact time, the data transmission rate during what contact time is available is increased. High data rates in the RF require some combination of high transmitter power and high-gain antennas on the satellite and the ground station. High power transmitters and high-gain antennas on the space segment are constrained by power and mass limitations on the satellite. High-gain antennas on the ground are not mass limited, but tend to be very large (10 meters or more in diameter) and require significant capital investment.

As data produced in LEO increases substantially with more satellites launched, downlink infrastructure must grow to meet demand. However, a more fundamental limitation to downlink rates will be encountered in the future, simply due to the overuse of available RF bandwidth in the space environment. Furthermore, simply adding new RF ground terminals will not solve the problem, because the ground stations will start to interfere with one another. Similarly, RF bandwidth is constrained on the space side. For example, when two satellites are relatively close to one another, their RF signals can interfere.

For new satellite companies leveraging advances in satellite costs, capital investment for an extended ground station network is particularly burdensome because the size and cost of the ground network does not scale with the size of the satellites. Ground station costs have not scaled at the same rate as satellite costs, requiring significant investment to match growth in satellite capacity.

Laser communication has the potential to provide data rates adequate to handle all the data generated on orbit for the foreseeable future. However, current laser communication technology requires installation of expensive laser transmitters on each satellite, and places operational constraints on the satellite (pointing, jitter, etc.) that are often beyond the capability of budget satellites.

A distributed constellation of satellites in Earth orbit, called network satellites, may enhance the utility of client satellites in Earth orbit by providing a high-bandwidth data link to ground. Client satellites may include any satellite in Earth orbit that collects data at a high rate, where high can mean that satellite operations are constrained by availability of communications bandwidth, or that satellite operations requires one or more dedicated ground stations. The network satellites may receive data at close range from the client satellites, and subsequently transfer the client data to the ground using optical communication. The system may also include several widely-distributed optical ground stations for receiving data from the network satellites.

The network satellites may have high-gain RF receivers to receive data from client satellites at ranges up to thousands of km. In addition, the network satellites may have laser communication transmitters to send data to the ground. Another form of the network satellites have both laser transmitters and optical receivers (telescopes) to receive data transmitted by other laser systems.

In both types of network satellites, simultaneous operation of both the receive mode and the transmit mode would not be possible because the pointing requirements of the receiver (whether optical or RF) would be incompatible with the pointing requirements of the transmitter.

Currently, the use of a complex gimbal system is required to address these issues. The complex gimbal system allows the laser to point in the required direction and with its required degree of precision, while the rest of the satellite would point as necessary to receive the incoming signal. Such gimbal systems, however, tend to be expensive. In addition, with any gimbaled system, the pointing direction of the laser is never independent of the attitude of the rest of the satellite, with consequent constraints on operation of the laser communication system.

Thus, a simple and versatile relay satellite node may be beneficial.

### SUMMARY

Certain embodiments of the present invention may provide solutions to the problems and needs in the art that have not yet been fully identified, appreciated, or solved by current nodes. For example, in some embodiments, a relay node in a space-based optical network is provided by a two-satellite system. In the two-satellite system, one of the two satellites operates in a receive mode, and the other satellite operates in the transmit mode. The two satellites fly in close proximity to one another, and data transfer between the two satellites is provided by omnidirectional RF or optical systems, or by RF or optical systems with relaxed pointing requirements. In this embodiment, both the receiving satellite and the transmitting satellite can point to the required degree of precision at their respective targets without interfering with one another and without requiring a mechanical gimbal between them.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 illustrates a communication satellite network having a network link from client satellite to ground, according to an embodiment of the present invention.

FIG. 2 illustrates a communication satellite network having a network link between two ground stations, according to an embodiment of the present invention.

### DETAILED DESCRIPTION OF THE EMBODIMENTS

One or more embodiments of the present invention pertain to a relay node in a space-based communications network comprising multiple nodes where each node consists of two or more satellites. The communication network may include multiple nodes widely distributed in one or more orbits about the Earth. The separation between nodes in the network may be in excess of 1000 km. It will be understood by those skilled in the art that, because of orbital dynamics, two nodes may occasionally approach one another and be, temporarily, separated by a distance less than 1000 km. In general, however, two nodes not in the same orbit will spend most of the time separated by distances well in excess of 1000 km. Because of the long range, communication between nodes is provided using highly-directional communication beams, either radio-frequency (RF) or optical. Such directional beams may have beam widths less than ten degrees (RF) or less than one degree (optical). The use of directional communication beams requires that the transmitter point at the receiver when transmitting and that the receiver point at the transmitter when receiving.

In a node consisting of two satellites, the two satellites of the node may fly in close proximity to one another, and data transfer between the two satellites in the node is provided by a short-range RF or optical communication system. For example, the two satellites may fly within 10 km of one another to enable short range communication. Such short-range communication can utilize omnidirectional beams, or beams that are directional, but with very wide beam widths (greater than 30 degrees, for example). In a two-satellite node as in this embodiment, the first of the two satellites, called the receiver satellite, operates in a receive mode for receiving communications from a long-range directional beam. The second of the two satellites, called the transmitter satellite, operates in a transmit mode for transmitting communications on a long-range directional beam. The receiver satellite also transmits communications over a short-range link with the transmitter satellite. In this embodiment, both the receiving satellite and the transmitting satellite can point with the required degree of precision at their respective targets for their respective long-range communications links. At the same time, maintaining the short-range communication link between them imposes little or no pointing requirements that might interfere with the precision pointing required for the long-range links.

In one embodiment, a communication satellite network may include a series of data- transmission nodes. Each data-transmission node includes two satellites in close proximity to each other and operating in conjunction with one another. For example, the first satellite, e.g., a receiver satellite, includes a receiver for receiving data from either a client satellite or another node in the network. The receiver satellite may include an optical telescope for receiving optical signals, or a high-gain RF receiver for receiving RF signals. The attitude-control system of the receiver satellite may point the satellite at the signal source to maintain signal quality. The receiver satellite also includes an omnidirectional short-range transmitter. The short range transmitter may be an RF transmitter or an optical transmitter such as a set of light-emitting diodes.

The second satellite, e.g., transmitter satellite, may include a transmitter for transmitting data to another node in the network, to a ground station, or to a client satellite. This transmitter may be a laser transmitter in some embodiments. In certain embodiments, the transmitter may be a high-gain RF transmitter. The attitude-control system of the transmitter satellite may point the satellite at the intended signal receiver to maintain signal quality. The transmitter satellite may also include an omnidirectional short-range receiver for receiving data from the receiver satellite. The short range receiver may be an RF receiver or an optical receiver. The mode of operation of the short-range receiver is chosen to match the mode of operation of the short-range transmitter of the receiver satellite.

During operation, the two satellites work together to transmit data continuously through the node. In some embodiments, data received at the receiver satellite may be immediately transmitted, using the short-range transmitter, to the transmitter satellite. The data received by the short-range receiver on the transmitter satellite may then be transmitted to the next node in the system.

In certain embodiments, the two satellites may be configured to allow operation of the node in the reverse direction, e.g., when a reverse data flow for handshaking between the nodes exists, or data flow in the other direction is more convenient. In these embodiments, the receiver satellite may include an RF transmitter (e.g., configured to use the same high-gain antenna as the receiver) or a laser transmitter aligned to be co-linear with the laser receiver telescope. The receiver satellite may also include a short-range receiver. The transmitter satellite may include an optical receiver telescope (co-linear with the laser transmitter) or an RF receiver using the same high-gain antenna as the RF transmitter. The transmitter satellite may include a short-range transmitter compatible with the short-range receiver on the receiver satellite. In effect, the system may become fully symmetric, allowing data to flow in either direction. This is possible because each satellite still has to point at only one target. In this embodiment, the two satellites may be identical to one another and may act as either receiver or transmitter satellite as necessary.

In another embodiment, the single omnidirectional communication system may be replaced with multiple, small, directional, but broad-beam, communication systems, such as a set of LEDs or various RF antennas, that together enable communication in any direction. The satellites may operate their attitude-control systems to optimize communication with their respective distant targets. However, the satellites may also have knowledge of the relative position of the two satellites of the node, and may operate the short-range communication system on the link with the best connection for any given position and orientation. The satellites may also continuously monitor the link quality of the various broad-beam communication systems to select the system with the best link quality.

In yet another embodiment, the node may include more than two satellites, all flying in close proximity to one another. This embodiment may allow the node to transmit an incoming data set in two outbound directions simultaneously, or to switch rapidly from one destination target to another (as may be required by the changing positions of the satellites as they orbit the Earth). As an example of such switching, consider the scenario where data is reaching the node from a source and is being transmitted to a ground station by a first transmitter satellite. As the node orbits the Earth, that ground station will eventually pass beyond the field of view of the first transmitter satellite. Another ground station at a different location may be coming into view. It may not be possible for the first transmitter satellite to instantly switch and begin transmitting to the second ground station because it takes time for the first transmitter satellite to reorient itself to point at the second ground station.

However, with more than two satellites in the node, it may be possible for a second transmitter satellite to orient itself to point at the second ground station while the first transmitter satellite is still transmitting to the first ground station. The second transmitter satellite, receiving the same omnidirectional transmission as the first transmitter satellite, may start transmitting to the second ground station before the first ground station is lost from view.

In a further embodiment, a storage device may be provided for storing data on board either of the satellites in the node. This way, in the event that one of the transmit links is broken, the data will not be lost. The data may then be re-transmitted when the link is re-established. This may allow either satellite to operate as a node in a store-and-forward mode where the satellite first acts as a receiver by pointing at and receiving data from a source, and later acts as a transmitter by pointing at and sending data to another node in the network.

In addition to the data-transmission nodes, the overall network may include data source nodes and data destination nodes. Examples of data source nodes may include, but are not limited to, imaging satellites, aircraft, or ground stations. Data destination nodes may include, but are not limited to, other satellites, aircraft, or ground stations. It may also be possible for the satellites of data-transmission nodes to have sensors, e.g., imagers or radiation monitors, to generate data that is then passed into and through the network.

During operation of this system, two satellites of the node may remain in close proximity to one another to enable the use of the omnidirectional communications link between the two satellites. To minimize the propulsion requirements, the two satellites may have similar mass and drag profiles. This may minimize their tendency to drift apart due to atmospheric drag. In addition, each satellite may have a sufficiently irregular shape such that the satellites can fly in either a high-drag or low-drag mode. For example, each satellite may be in the form of 3U CubeSats, and have deployable wings for solar power. If the wings hinge on one of the long sides of the 3U CubeSat, then deploying the wings may provide a large drag differential between a flight path edge-on to the wings and a flight path face-on to the wings. In some embodiments, a ground station may provide commands to one or more of the satellites in a relay node to change orientation and drag mode and thereby maintain proximity between the satellites. The commands may be provided directly, or via relay from another relay node. In some embodiments, the satellites may autonomously change orientation and drag mode in order to maintain proximity to one another.

During normal operation, the satellites of a node may be flown in orientations designed to minimize their relative separation. This operating mode may be used at all times, except when the satellites are required to take specific orientations to enable communication.

In some cases, the use of attitude-driven variable drag may be insufficient to maintain relative separation requirements. This may be due to operation at altitudes where drag is too low or due to excessive communication time requirements that interfere with variable-drag operations. In those cases, a propulsion system may be utilized to maintain separation.

Because the relay satellites can be small and simple (e.g., a 3U CubeSat may be adequate, and 1.5U may also be sufficient, depending on requirements), initial deployment of the satellite network can be relatively inexpensive. An individual node may, for example, be launched as two CubeSats from the same deployer, or even launched as a single CubeSat (3U or 6U) that may then separate into the two nodes. For a symmetric system operating with bi-directional communication, both satellites in a single node could be identical. For a unidirectional system, there may be two types of satellites.

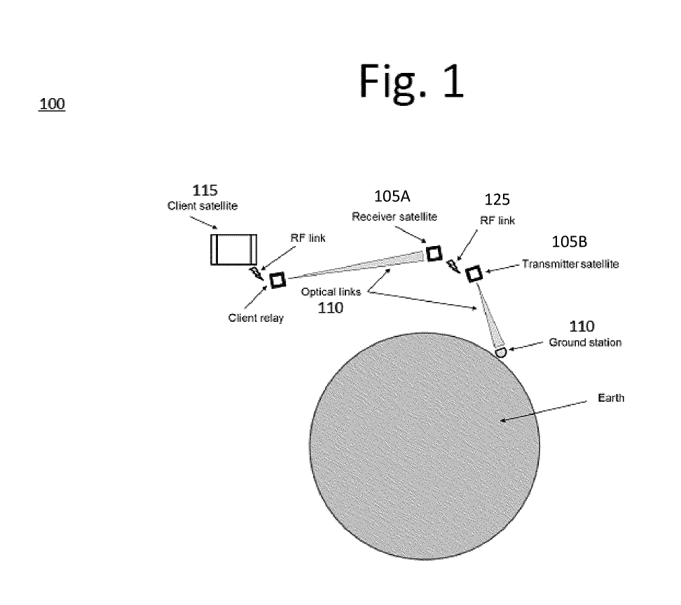

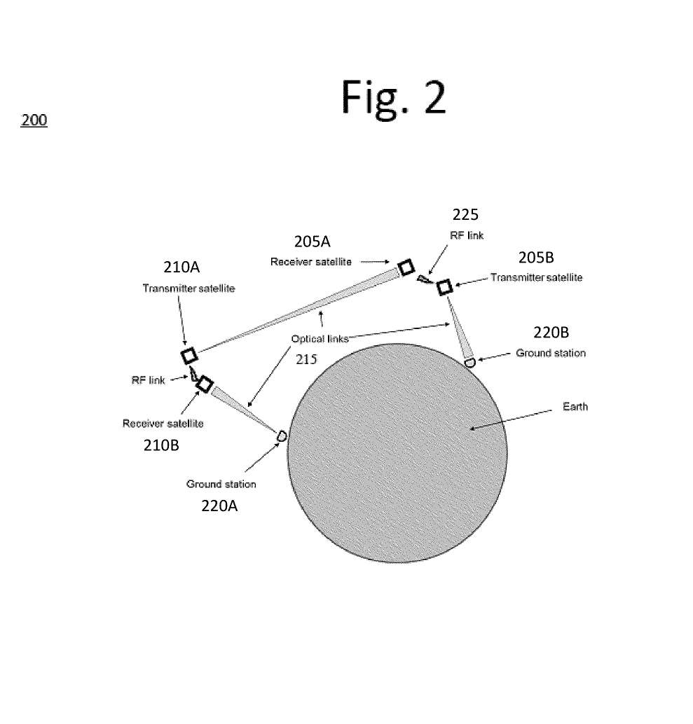

A large system of nodes may thus be deployed in LEO for a very modest cost. For a system of nodes deployed in a single orbital plane, spare satellites may be provided that can be moved through the orbit (using propulsion or variable drag) to replace failed satellites. By providing multiple nodes in a single plane, a few satellites may serve as spares for every satellite in the plane. Use of this system is illustrated in FIGS. 1 and 2.

In FIG. 1, for example, communication satellite network 100 may include a relay node. The relay node may include a receiver satellite 105A and a transmitter satellite 105B, and may provide an optical link 110 between a client satellite 115 and a ground station 120. The relay node has a short-range link 125 between the receiver satellite 105A and the transmitter satellite 105B. In FIG. 2, for example, communication satellite network 200 may include a plurality of relay nodes, each having a receiving satellite 205A, 210A and a transmitting satellite 205B, 210B. The relay node has a short-range link 225 between the receiver satellite 205A and the transmitter satellite 205B. The relay nodes provide a link 215 between ground stations 220A, 220B.

The relay satellite system described above provides a method for continuous throughput in a LEO optical communications network without the use of expensive and complex gimbals between the receivers and the transmitters. A distributed array of these relay satellite pairs may enable real-time downlinking of large data sets with no latency.

One or more embodiments described herein may include a relay satellite node that provides a communication solution to satellite operators unwilling to establish their own RF downlink network. The relay satellite node may provide higher data rates than are available with existing RF systems. In some embodiments, optical communication may provide improved data security because the beam diameter can be substantially smaller than comparable RF systems. During operation, it may be possible to make the beam ground footprint as small as a few tens of meters. This way, it may be possible to maintain ownership/control over the entire ground footprint, substantially reducing opportunities for eavesdropping. Furthermore, optical communications may be less susceptible to interference and harder to jam than RF communications.

The relay satellite node described herein may also provide reduced data latency compared to single-user systems. The relay satellite nodes further provide for higher utilization of the space assets by offloading the data transmission task and reducing data storage requirements. Additionally, the relay satellite node may provide for a reduced satellite power envelope by reducing transmission power requirements.

In some embodiments, the relay satellite node may provide higher availability by having widely distributed ground systems that will limit outages due to atmospheric conditions. In further embodiments, relay satellite nodes may provide an efficient link in a space-based optical connection between two ground points.

It will be readily understood that the components of various embodiments of the present invention, as generally described and illustrated in the figures herein, may be arranged and designed in a wide variety of different configurations. Thus, the detailed description of the embodiments, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

1. A multi-satellite relay node for relaying data from another satellite, said relay node comprising:
a first relay satellite and a second relay satellite to be maintained in close proximity to the first relay satellite, while orbiting,
wherein the first relay satellite comprises:
a long-range communications receiver configured to receive client data from the other satellite, and
a first short-range communications transceiver configured to transmit received client data to the second relay satellite; and
wherein the second satellite comprises:
a second short-range communications transceiver configured to receive client data from the first short-range transceiver, and
a long-range communications transmitter configured to relay the client data to yet another satellite or a ground station.

2. The relay node of claim 1, wherein the first and second short-range communications transceivers communicate via an RF signal having relatively relaxed pointing requirements as a function of the close proximity between the first and second relay satellites.

3. The relay node of claim 1, wherein the first and second short-range communications transceivers communicate via an optical signal having relatively relaxed pointing requirements as a function of the close proximity between the first and second relay satellites.

4. The relay node of claim 1, wherein the first and second short-range communications transceivers communicate via a plurality of directional broad-beam communication systems configured such that the plurality of directional broad-beam communication systems enable communication in any direction.

5. The relay node of claim 1, wherein the long-range communications transmitter is an optical laser transmitter.

6. The relay node of claim 1, wherein the receiver of the first relay satellite receives an optical signal from the other satellite.

7. The relay node of claim 1, further comprising a third satellite, the third satellite comprising:
a third short-range communications transceiver configured to communicate with the first satellite, and
a long-range communications transmitter configured to transmit data to another satellite or to a ground station.

8. The relay node of claim 1, wherein the first relay satellite further comprises a first variable-drag structure configured to allow the first satellite to fly in a low-drag mode or a high-drag mode.

9. The relay node of claim 8, wherein the variable-drag structure is a deployable solar panel wing, and wherein the low-drag mode is a flight path edge-on to the wings.

10. The relay node of claim 1, wherein the first relay satellite further comprises a propulsion unit to maintain separation from the second relay satellite.

11. The relay node of claim 1, wherein the first relay satellite and second relay satellite are configured to be launched together and separated after reaching orbit.

12. A method for relaying data from a client satellite to off-load downlink communications and relax pointing requirements for the client satellite, comprising:
a first relay satellite receiving data from a client satellite via a first communications link;
the first relay satellite transmitting data to a second relay satellite via a short-range link; and
the second relay satellite transmitting the data received from the first relay satellite to a ground station or another satellite via a long-range optical communications link.

13. The method of claim 12, further comprising:
the first relay satellite storing the received data in a receiver memory, where it may be stored until the short-range link to the second relay satellite is connected; and
the second relay satellite storing the data received from the first relay satellite in a transmitter memory, where it may be stored until the long-range optical communications link is connected.

14. The method of claim 12, further comprising:
the first relay satellite sensing sensor data;
transmitting it to the transmitter satellite via the short-range link to the second relay satellite; and
the second relay satellite transmitting the sensor data to a ground station or another satellite via the long-range optical communications link.

15. The method of claim 12, wherein the first communications link is an optical communication link.

16. The method of claim 12, further comprising orienting one or both of the first relay satellite and second relay satellite alternately in a low drag mode and a high drag mode in order to maintain separation between the first and second relay satellites.

17. The method of claim 12, further comprising:
the first relay satellite transmitting client data to a third relay satellite via a short-range link; and
the third relay satellite transmitting the client data received to a ground station or another satellite via a long-range optical communications link.

18. The method of claim 17, wherein the direction between the second relay satellite and a ground station and the direction between the third relay satellite and another ground station are different by more than the beam width of the first communications link.
